(19) United States
(12) Patent Application Publication
(10) Pub. No.: US 2012/0237759 A1
(43) Pub. Date: Sep. 20, 2012

(54) COMPOSITE MATERIAL OF OPEN-CELL RIGID FOAM

(75) Inventors: Hubert Ehbing, Odenthal (DE); Hans-Jürgen Liebig, Leverkusen (DE)

(73) Assignee: Bayer Materialscience AG, Leverkusen (DE)

(21) Appl. No.: 13/498,370

(22) PCT Filed: Sep. 30, 2010
(86) PCT No.: PCT/EP10/64531

§ 371 Date: Jun. 5, 2012

(30) Foreign Application Priority Data
Oct. 1, 2009 (DE) 10 2009 048 000.5

(51) Int. Cl. B32B 3/26; B32B 37/12; B32B 37/10; B32B 27/40

(52) U.S. Cl. 428/319.3; 428/304.4; 156/60; 156/285

(57) ABSTRACT

The present invention relates to a composite material, comprising a sandwich element (4) and a functional and/or decorative layer (3). The sandwich element (4) comprises at least one core layer (1), comprising an open-cell rigid foam, and at least one outer layer (2) located on each side of this core layer.

The present invention relates to a composite material comprising a spacer sandwiched between two fibrous layers.

Composite materials are materials consisting of two or more materials bonded to each other. The properties of the material obtained are determined by material and perhaps also geometric properties of the individual components. This enables properties of different components to be combined, whereby the composite materials find a broad range of possible applications. The properties required for the final product can be adjusted according to need by selecting different starting materials for the components.

Composite materials can be produced in any of several ways. One possibility is sandwich design. This design is frequently used for semifinished products in which several layers with different properties are embedded in a material. As a construction method, the sandwich design is a form of lightweight construction in which the components consist of cover layers, which usually take up the forces, kept in mutual distance by a relatively soft and mostly lightweight core material (spacer). The corresponding parts are highly resistant to bending while their weight is low.

The core material may consist of honeycombs made of different materials, for example, paper, cardboard, plastics or metals, balsa wood, corrugated metal sheet or foams. It transmits shear forces and supports the cover layers.

Applications for composite materials produced by the sandwich method include, for example, recreational crafts, airplane parts (fuselage, wing covers), railroad cars, vehicle and automobile parts, surfboards and rotor blades for wind turbines.

Sandwich panels with a honeycomb core of aramid fibers and cover layers of glass fiber prepregs are also used as walls for galleys and toilets in modern aircraft.

In the construction field, prefabricated sandwich panels consisting of a steel-reinforced concrete shell, a heat insulation and a facing panel of clinker or concrete are used. In addition, composite boards with metallic cover layers and intermediate heat insulation are referred to as sandwich elements or sandwich panels.

In shipbuilding, this design is already widespread, especially in recreational crafts. In the construction of large vessels, the sandwich design promises more safety, more particularly in tankers.

The sandwich design is also employed in automobile construction. Thus, a high stability can still be achieved together with a low weight. The preparation of a fiber-reinforced plastic sandwich component is known, for example, from DE 10 057 365 A1.

Roof modules for motor vehicles that are based on sandwich design are known from WO 2006/099939 A1 and WO 2009/043446 A2.

The sandwich design is also used in solar technology. Thus, a solar module including a sandwich element as a backside cover is known from the as yet unpublished PCT/EP2009/003951.

In addition, a sandwich element consisting of a metal foil as a spacer between two waterproof sheets is known from US 2003/0178056 A1. In this case too, the design is used as a backside cover of a solar panel. A similar design consisting of a metal foil and sealing polymer layers for solar panels is also known from DE 102 31 401 A1.

Honeycomb structures or corrugated metal sheets are frequently used as spacers in a sandwich element. These spacers usually have an outer layer on both sides. This outer layer often consists of plastic sheets. The bonding of such sheets with the spacer is usually effected at a high temperature and under pressure. The structure of the spacer is often outlined through the sheet, so that the surface of the sandwich element is no longer smooth. The structure of the spacer then also shows in the final product.

When such a sandwich element is used as a construction material that is visible later, such an irregular surface is undesirable. For example, when used in a solar panel, such an irregular surface has the effect that the individual solar cells may be damaged already when the laminate is prepared.

The irregular surfaces caused by honeycomb structures and the destruction of the solar panels can be prevented in principle by using a closed-cell rigid foam core as a spacer. A disadvantage of this prior art solution is the fact that such composite materials are prepared by pressing, which involves providing the functional or decorative layer first. Subsequently, the sandwich element, whose reaction is not yet completed, is applied and pressed thereon. Air trapped between the functional layer and the sandwich element cannot escape because neither the functional layer nor the core can absorb air or let it pass through. Also, lateral escaping is not possible in large structures because of the long distances. This results in bubbles leading to surface defects or even destruction of the functional layer.

The use of honeycomb structures that can contain air is also known in the prior art, but has the disadvantage that the honeycomb structure is outlined by the pressing process on the functional or decorative layer or even destroys it.

Therefore, the object of the present invention is to provide a composite material that can be obtained in a sandwich design and avoids the drawbacks of the prior art. In particular, a corresponding composite material is supposed to have a smooth surface (class A finish), also over large areas, in which the structure of the spacer is not visible. The surface should be very smooth and have no dents, air inclusions or similar defects. The surface of the sandwich element should be so even that functional elements, for example, solar panels, can be attached thereto without being damaged already by the sandwich element, or by the spacer becoming outlined on the surface.

Surprisingly, it has been found that a rigid foam core having a defined open-cell percentage can absorb air trapped during the pressing process without adversely affecting the composite. At the same time, this rigid foam core has a sufficiently high modulus in compression or a sufficiently high compressive strength, so that the rigid foam core will not collapse when the composite is pressed. The fibrous layers between which the rigid foam core is provided are tightly bonded to the core. Because of the selected rigidity of the rigid foam core, the structure according to the invention also has sufficient mechanical rigidity.

In a first embodiment, the object of the invention is achieved by a composite material consisting of a spacer (1) sandwiched between two fiber-filled polyurethane layers (2), characterized in that said spacer includes an open-cell rigid foam.

Suitable open-cell rigid foam cores include those based on polyurethane, for example. Further, open-cell (reticulated) PVC, PE, PP, PET, PS or EPS foams or open-cell metallic or ceramic foams, for example, are also suitable as spacers.

The structure according to the invention can be used, for example, for preparing exterior components of motor vehicles (roof modules) if the functional layer is a plastic or decorative sheet. Solar modules may also be prepared if the functional layer is a thin-film solar laminate.

According to the invention, such an open-cell rigid foam has a bulk density of 30 to 150 kg/m³, preferably 40 to 120 kg/m³, more preferably 50 to 100 kg/m³ (measured according to DIN EN ISO 845). These rigid foams have an open-pore fraction of ≧10%, preferably ≧12%, more preferably ≧15% (measured according to DIN EN ISO 4590-86), a compression strength of ≧0.2 MPa, preferably ≧0.3 MPa, more preferably ≧0.4 MPa (measured in a compression test according to DIN EN ISO 826) and a modulus of elasticity in compression of ≧6 MPa, more preferably ≧10 MPa (measured in a compression test according to DIN EN ISO 826). In particular, a composite material according to the invention further comprises a functional and/or decorative layer (3).

Experience shows that (PUR) rigid foams having bulk densities of >150 kg/m³ are closed-cell. By an additional process step (for example, reticulation=the purposeful opening of the foam cells by positive or negative pressure in an autoclave), open-cell foams having higher bulk densities and rigidities or strengths may also be obtained and employed.

The advantage of the present invention over composite materials described in the prior art resides in the fact that, when it is used as a backside cover in solar laminates, as a roof module or other component, any air trapped during the production process can escape through or be absorbed by the open-cell rigid foam. From processes for obtaining corresponding products, it is known that usually the sandwich element (4) is provided first, then applying a decorative and/or functional layer (3) through optional adhesive layers. When this decorative and/or functional layer (3) is applied, there is air between it and the underlying sandwich element (4). During the bonding process, pressure is applied, optionally at elevated temperature, and a vacuum may also be applied. With small-area composite materials, the air can now escape through the edges. With large-area materials, however, this is not possible. Therefore, the air remains trapped between the sandwich element (4) and the functional and/or decorative layer (3).

In a sandwich element (4) according to the invention, the spacer (1) has such a design that the air can be absorbed or escape through the open cells of the rigid foam. This avoids air inclusions between the sandwich element (4) and the functional and/or decorative layer (3).

According to the invention, there is a spacer (1) between two fibrous layers (2). These fibrous layers (2) are usually fibrous materials impregnated with a resin, especially a polyurethane resin. The polyurethane resin employed is obtainable by reacting
a) at least one polyisocyanate;
b) at least one polyol component with an average OH number of from 300 to 700, which includes at least one short-chain and one long-chain polyol, the starting polyols having a functionality of 2 to 6;
c) water;
d) activators;
e) stabilizers;
f) optional auxiliary agents, mold release agents and/or additives.

Suitable long-chain polyols preferably include polyols having at least two to mostly six isocyanate-reactive H atoms; preferably employed are polyester polyols and polyether polyols having OH numbers of from 5 to 100, preferably from 20 to 70, more preferably from 28 to 56.

Suitable short-chain polyols preferably include those having OH numbers of from 150 to 2000, preferably from 250 to 1500, more preferably from 300 to 1100.

According to the invention, higher-nuclear isocyanates of the diphenylmethane diisocyanate series (pMDI types), prepolymers thereof of mixtures of such components are preferably employed.

Water is employed in amounts of from 0 to 3.0, preferably from 0 to 2.0, parts by weight on 100 parts by weight of polyol formulation (components b) to f)).

The per se usual activators for the chain-propagation and cross-linking reactions, such as amines or metal salts, are used for catalysis.

Polyether siloxanes, preferably water-soluble components, are preferably used as foam stabilizers. The stabilizers are usually applied in amounts of from 0.01 to 5 parts by weight, based on 100 parts by weight of the polyol formulation (components b) to f)).

To the reaction mixture for preparing the polyurethane resin, there may optionally be added auxiliary agents, mold release agents and additives, for example, surface-active additives, such as emulsifiers, flame retardants, nucleating agents, antioxidants, lubricants, mold release agents, dyes, dispersants, blowing agents, and pigments.

The components are reacted in such amounts that the equivalent ratio of the NCO groups of the polyisocyanates a) to the sum of the isocyanate-reactive hydrogens of components b) and c) and optionally d), e) and f) is from 0.8:1 to 1.4:1, preferably from 0.9:1 to 1.3:1.

Further, as resins for the fibrous layers, there may also be employed thermoplastic materials, such as PE, PP, PA or other thermoplastic materials known from the prior art. Thermosetting molding compositions, such as epoxy resins, unsaturated polyester resins, vinyl ester resins, phenol-formaldehyde resins, diallyl phthalate resins, methacrylate resins or amino resins, such as melamine resins or urea resins, may also be employed as resins for the fibrous layer.

As the fibrous material for the fibrous layers, there may be employed glass fiber mats, glass fiber webs, glass fiber random fiber mats, glass fiber fabric, chopped or ground glass or mineral fibers, natural fiber mats and knits, chopped natural fibers, as well as fibrous mats, webs and knits based on polymer, carbon and aramid fibers, as well as mixtures thereof.

Such a fibrous layer (2) provides the spacer made of open-cell rigid foam (1) with the rigidity needed in the final product. In addition, a layer (2) according to the invention is permeable to air.

Therefore, a sandwich element (4) according to the invention is suitable, for example, for preparing solar panels. In this case, a solar laminate is employed as the functional layer (3). During operation, such a solar laminate has a transparent layer facing a light source, and an adhesive layer bearing at least one solar cell.

Said transparent layer may be made of the following materials: glass, polycarbonate, polyester, poly(methyl methacrylate), polyvinyl chloride, fluorine-containing polymers, epoxides, thermoplastic polyurethanes, or any combinations of such materials. Further, transparent polyurethanes based on aliphatic isocyanates may also be used. HDI (hexamethylene diisocyanate), IPDI (isophorone diisocyanate) and/or H12-MDI (saturated methylenediphenyl diisocyanate) are employed as isocyanates. Polyethers and/or polyester polyols are employed as the polyol component, and chain extenders are used, aliphatic systems being preferably used.

The transparent layer may be embodied as a plate, plastic sheet or composite sheet. Preferably, a transparent protective layer may be applied to the transparent layer, for example, in the form of a paint or plasma layer. The transparent layer could be made softer by such a measure, which may further reduce stresses in the module. The additional protective layer would take up the protection against external influences.

The adhesive layer preferably has the following properties: a high transparence within a range of from 350 nm to 1150 nm, and a good adhesion to silicon and to the material of the transparent layer, and to the sandwich element. The adhesive layer may consist of one or several adhesive layers, which are laminated onto the transparent layer and/or the sandwich element.

The adhesive layer is soft in order to compensate for stresses caused by the different coefficients of thermal expansion of the transparent layer, solar cells and sandwich element. The adhesive layer is preferably made of a thermoplastic polyurethane, which may optionally be provided with colorants. Alternatively, the adhesive layer may also be made of, for example, ethylene-vinyl acetate, polyethylene, polyvinyl butyral, or silicon rubber.

In addition to a functional layer (3), a sandwich element according to the invention may also have a decorative layer (3). A corresponding composite material will be suitable, for example, for preparing construction parts in automobile construction. For example, a roof module with a class A finish can be prepared from a composite material according to the invention.

As the decorative layer (3), generally known sheets, especially thermoplastic sheets, may be employed, for example, usual sheets based on acrylonitrile-butadiene-styrene (ABS), poly(methyl methacrylate) (PMMA), acrylonitrile-styrene-acrylic ester (ASA), polycarbonate (PC), thermoplastic polyurethane, polypropylene, polyethylene and/or polyvinyl chloride (PVC). Preferably, a two-layer sheet is used as said thermoplastic decorative layer (3), the first layer being based on PMMA and the second layer on ASA and/or PC. Further, coated or painted sheets may also be used. Sheets based on acrylonitrile-butadiene-styrene (ABS), poly(methyl methacrylate) (PMMA), acrylonitrile-styrene-acrylic ester (ASA), polycarbonate (PC), thermoplastic polyurethane, polypropylene, polyethylene and/or polyvinyl chloride (PVC) are in turn suitable as substrate layers.

All the usual metal foils may also be used as said decorative layer (3); preferably, an aluminum foil or a steel foil, especially a so-called aluminum coil coating, is used.

Such decorative layers (3) are commercially available, and the preparation thereof is generally known. The above mentioned sheets generally have a thickness of from 0.2 to 5 mm, preferably from 0.5 to 1.5 mm.

For example, coextruded sheets with a spacer layer of polycarbonate or ABS (acrylonitrile-butadiene-styrene) and a surface layer of PMMA (poly(methyl methacrylate)) are also employed as the decorative layer (3). However, monosheets of ABS are also possible. They preferably have a modulus of elasticity of above 800 MPa, preferably from 1000 MPa to 100,000 MPa, so that their intrinsic rigidity provides for some basic stability.

In another embodiment, a composite material according to the invention has a plastic frame. Such a plastic frame protects the spacer (1) from moisture, air or other environmental influences, which may intrude through the sides, which are not covered by the fiber-filled polyurethane layers (2). The quality of the entire sandwich element (4) may be highly affected by the intrusion of moisture. In this case, a homogeneous surface and thus a good optical appearance and a good adhesion of the functional and/or decorative layer (3) is no longer ensured. Such influences are prevented by a frame according to the invention.

A plastic frame according to the invention preferably also consists of fiber-reinforced polyurethane, especially glass-fiber reinforced polyurethane. Such a polyurethane is obtainable, for example, by reacting organic di- and/or polyisocyanates with at least one polyether polyol. Suitable isocyanate components include aliphatic, cycloaliphatic, araliphatic, aromatic and heterocyclic polyisocyanates as described, for example, by W. Siefken in Justus Liebigs Annalen der Chemie, 562, pages 75 to 136.

Polyols having a functionality of 2 to 8, especially of 2 to 4, a hydroxyl number of 20 to 1000 mg of KOH/g, preferably from 25 to 500 mg of KOH/g, and from 10 to 100% of primary hydroxy groups are preferably used as polyether polyols. The polyols generally have a molecular weight of from 400 to 10,000 g/mol, preferably from 600 to 6000 g/mol. Polyether polyols are particularly preferred because of their higher hydrolytic stability.

In a preferred embodiment, a mixture of at least two polyether polyols is used, the first polyether polyol having an OH number of from 20 to 50, preferably from 25 to 40, and the second polyether polyol having an OH number of from 100 to 350, preferably from 180 to 300, the weight ratio of the first to second polyether polyols being generally from 99:1 to 80:20.

A polyurethane plastic material according to the invention, from which the frame according to the invention is formed, optionally contains further different polyether polyols, polymer polyols and optionally chain extenders. Further, the presence of amine catalysts, metal catalysts and optionally other additives is possible. Surface-active additives, such as emulsifiers, foam stabilizers, stabilizers, lubricants, mold release agents, dyes, dispersants and/or pigments as known from the prior art may be used as additives.

In another embodiment, the object of the present invention is achieved by a process for preparing a composite material according to the invention. Such a process is characterized in that
i) a sandwich element (4) consisting of at least one spacer of an open-cell rigid foam and at least one fiber-filled polyurethane layer (2) provided on either side of this spacer (1) is provided;
ii) optionally, an adhesive layer in the form of a plastic sheet or as a casting composition is applied to an exposed surface of the sandwich element (4);
iii) a functional and/or decorative layer (3) is applied; and
iv) this laminate is pressed, optionally under the influence of temperature and/or optionally with applying a vacuum.

In an alternative process, the order of providing the individual layers may also be changed. Therefore, another process according to the invention for preparing a composite material is characterized in that
i) a functional and/or decorative layer (3) is provided;
ii) optionally, an adhesive layer in the form of a plastic sheet or as a casting composition is applied to said layer (3);
iii) a sandwich element (4) consisting of at least one spacer (1) of an open-cell rigid foam and at least one outer layer (2) provided on either side of this spacer (1) is applied; and
iv) this laminate is pressed, optionally under the influence of temperature and/or optionally with applying a vacuum.

In another embodiment, the object of the present invention is achieved by the use of a composite material according to the invention as a solar module, roof module, automotive body part, structural part in vehicle, vessel or airplane construction, trim element or decorative element.

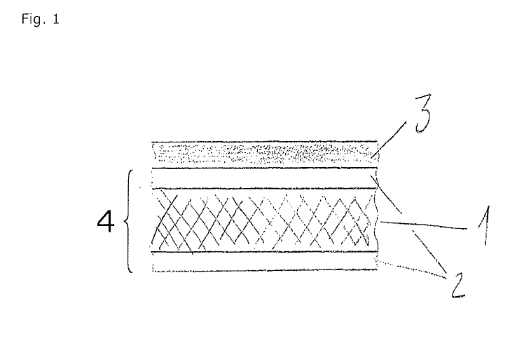

Using FIG. 1, the invention is further illustrated by way of example. In FIG. 1, the sandwich element (4) consists of a spacer (1), which is embedded between two fiber-filled polyurethane layers (2). A sandwich element (4) consisting of a spacer (1) and polyurethane layers (2) can now be bonded to a functional and/or decorative layer (3), optionally by means of an adhesive layer.

### EXAMPLE

To prepare a thin-film solar laminate, a 125 μm thick polycarbonate film (type Makrofol® DE 1-4 of Bayer MaterialScience AG, Leverkusen) was used as the front layer. Two 480 μm thick TPU films (type Vistasolar® of the company Etimex, Rottenacker, Germany) served as hot-melt adhesive layers. The individual components in the order of polycarbonate film, TPU film, 4 silicon solar cells and TPU film were superposed to form a laminate, evacuated in a vacuum laminator (NPC, Tokyo, Japan) at 150° C. for 6 minutes at first, and subsequently compressed under a pressure of 1 bar for 7 minutes to form a thin-film solar laminate.

A Baypreg® sandwich was used as the sandwich element. Thus, a random fiber mat of type M 123 having a weight per unit area of 300 g/m² (from the company Vetrotex, Herzogenrath, Germany) was laid on both sides of a polyurethane rigid foam plate of the type Baynat (system Baynat 81IF60B/Desmodur VP.PU 0758 from the company Bayer MaterialScience AG (thickness 10 mm, bulk density 66 kg/m³ (measured according to DIN EN ISO 845), open-pore fraction 15.1% (measured according to DIN EN ISO 845), modulus of elasticity in compression of 6 MPa, preferably 8 MPa, more preferably 10 MPa (measured in a compression test according to DIN EN 826), modulus of elasticity in compression (measured according to DIN EN 826) of 11.58 MPa, and compression strength of 0.43 MPa (measured according to DIN EN 826) for preparing the sandwich element. Subsequently, 300 g/m² of a reactive polyurethane system was sprayed on both sides of this structure using a high-pressure processing machine. A polyurethane system from Bayer MaterialScience AG, Leverkusen, consisting of a polyol (Baypreg® VP.PU 01IF13) and an isocyanate (Desmodur® VP.PU 08IF01) was used at a mixing ratio of 100 to 235.7 (index 129).

The assembly of a polyurethane rigid foam plate and the random fiber mats sprayed with polyurethane was also transferred into a compression mold on the bottom of which there had been previously inserted a TPU sheet (480 μm, type Vistasolar® from the company Etimex, Rottenacker, Germany). The mold was temperature-controlled at 130° C., and the assembly was compressed for 90 seconds to give a 10 mm thick sandwich solar module.

1.-12. (canceled)

13. A composite material consisting of a spacer sandwiched between two fibrous layers, wherein said spacer comprises an open-cell rigid foam having an open-pore fraction of greater than or equal to 10%.

14. The composite material according to claim 13, wherein said open-cell rigid foam is a PUR rigid foam.

15. The composite material according to claim 13, wherein said open-cell rigid foam has a bulk density of 30 to 150 kg/m3.

16. The composite material according to claim 13, further comprising at least one functional and/or decorative layer.

17. The composite material according to claim 13, wherein said functional layer is a solar laminate comprising a transparent layer facing a light source, and an adhesive layer bearing at least one solar cell.

18. The composite material according to claim 17, wherein said transparent layer comprises a plastic sheet or a glass pane.

19. The composite material according to claim 13, wherein said decorative layer comprises a sheet selected from the group consisting of sheets based on acrylonitrile-butadiene-styrene (ABS), poly(methyl methacrylate) (PMMA), acrylonitrile-styrene-acrylic ester (ASA), polycarbonate (PC), thermoplastic polyurethane, polypropylene, polyethylene, polyvinyl chloride (PVC), and combinations thereof; or
two-layer sheets, wherein the first layer is based on PMMA and the second layer is based on ASA and/or PC or comprises a coated or painted sheet selected from the group consisting of sheets based on acrylonitrile-butadiene-styrene (ABS), poly(methyl methacrylate) (PMMA), acrylonitrile-styrene-acrylic ester (ASA), polycarbonate (PC), thermoplastic polyurethane, polypropylene, polyethylene, polyvinyl chloride (PVC) and combinations thereof.

20. The composite material according to claim 13, wherein the composite material comprises a frame of plastic.

21. The composite material according to claim 20, wherein said frame comprises fiber-filled polyurethane.

22. A process for preparing the composite material according to claim 13, comprising
i) providing a sandwich element consisting of at least one spacer of an open-cell rigid foam and at least one fiber-filled polyurethane layer on either side of this spacer;
ii) optionally, applying an adhesive layer in the form of a plastic sheet or as a casting composition to an exposed surface of the sandwich element;
iii) applying a functional and/or decorative layer; and
iv) pressing the laminate, optionally under the influence of temperature and/or optionally while applying a vacuum.

23. A process for preparing the composite material according to claim 13, comprising
i) providing a functional and/or decorative layer;
ii) optionally, applying an adhesive layer in the form of a plastic sheet or as a casting composition to said functional and/or decorative layer;
iii) applying a sandwich element consisting of at least one spacer of an open-cell rigid foam and at least one outer layer on either side of the spacer; and
iv) pressing the laminate, optionally under the influence of temperature and/or optionally while applying a vacuum.

24. A solar module, roof module, automotive body part, structural part in vehicle, vessel or airplane construction, trim element or decorative element comprising the composite material according to claim 13.
